(19) United States
(12) Patent Application Publication
(10) Pub. No.: US 2005/0194576 A1
(43) Pub. Date: Sep. 8, 2005

(54) Conductive concrete compositions and methods of manufacturing same

(76) Inventors: D. Brien Sirola, Barrie (CA); Graham Hagens, Hamilton (CA)

Correspondence Address: DINESH AGARWAL, P.C., 5350 SHAWNEE ROAD, SUITE 330, ALEXANDRIA, VA, 22312, US

(21) Appl. No.: 11/124,243

(22) Filed: May 9, 2005

Related U.S. Application Data
(62) Division of application No. 10/643,149, filed on Aug. 19, 2003, now abandoned.
(60) Provisional application No. 60/404,129, filed on Aug. 19, 2002.

(51) Int. Cl. C04B 16/08; H01B 1/00

(52) U.S. Cl. 252/500; 106/814; 106/805; 106/802; 106/711

(57) ABSTRACT

Modified compositions for carbonaceous concrete conductive sheathing materials for ground electrodes are described, for use in protecting installations from electrical currents. By the incorporation of discrete fibers, superior freeze-thaw resistance is imparted. The water resistance of carbonaceous concretes according to the invention is improved by the addition of a soluble soap of long chain fatty acids. A method of precasting carbonaceous cements according to the invention allows uniform and consistent development of properties for use either in shallow trench or deep well applications.

This application claims priority based on U.S. provisional patent application No. 60/404,129 filed on Aug. 19, 2002, which is incorporated herein by reference.

### BACKGROUND OF THE INVENTION

Various electrical grounding techniques are utilized throughout the world for the prevention of electrical damage to buildings and equipment. Such grounding techniques find numerous applications in such diversified areas as power and telecommunication systems, electronic equipment, fuel storage tanks, industrial installations, commercial and residential buildings as well as buried equipment such as pipelines. The grounding techniques are also used to protect the buildings or equipment from a variety of electrical hazards ranging from the rapid and intense, such as a lightning strike, to the slow degradation caused by electrochemical corrosion.

The established grounding techniques commonly involve the use of wires or rods of copper or other electrically conductive metals being attached to the installation requiring protection, after which the metallic rod is buried or driven into the earth. In recent years it has been demonstrated that the use of metallic “lightning rods” of this type have certain disadvantages, one particular problem being the fact that the high current discharges incurred by lightning result in the electricity spreading across the ground surface rather than following the rod into the earth as intended. To this end various methods have been disclosed whereby the electrical current may be more effectively dissipated.

This has been accomplished by embedding the electrically conductive rods in a protective casing containing a conductive non-metallic material, which casings allow rapid dispersion of the electrical current in such a way as to avoid the dispersion of dangerous surface charges. According to this method conductive materials are introduced into a narrow trench which extends some distance from the immediate impact site, a metallic conductor is embedded within this material, and the trench then backfilled with soil.

In another art known as “cathodic protection,” electrical grounding installed such that a low level flow of current flows into a deeply buried anode to protect buried materials such as metallic pipes, from electrochemical corrosion.

The art of electrical grounding may be thus be conveniently divided into two classes: “Shallow trench” and “Deep Well” applications. The prior art in these two areas will now be briefly reviewed:

Electrical Grounding Techniques

(i) Shallow Trench Grounding

The use of shallow trench grounding using conductive backfill has been known for many years. See U.S. Pat. No. 2,495,466 (Miller); U.S. Pat. No. 2,553,654 (Heise). It is also known that the efficacy of such grounding techniques is often restricted by various cost and technical factors such as limited available ground areas, high resistivity soils or shallow soil depths to bedrock. For this reason considerable effort has been made in recent years to improve the efficiency of the casing used to contain the metallic conductor. One of the more effective casing materials consists of using combinations of the various forms of carbon in combination with a cementitious material to improve its strength and structural integrity.

Carbon is allotropic and is found widely in its crystalline and amorphous forms. It is found in coke in its amorphous form, while graphite and diamond provide examples of the crystalline form. Graphite, coke, and coke breeze have all been used to provide the conductivity of these systems, breeze being defined as small cinders, coke dust etc. which arise as by-product during the processing of coal or petroleum.

Of the various types of cements which can be used to reinforce the carbon, hydraulic cements such as Portland, blast furnace slag, fly ash etc., are to be preferred. Concrete and other cementitious compositions are normally prepared by mixing required amounts of hydraulic cement with fine and coarse aggregates and other additives known to the art, with required amounts of water. The terms ‘paste’, ‘mortar’ and ‘concrete’ are common in the art: pastes are mixtures composed of an hydraulic cement binder, usually, but not exclusively Portland cement, which itself is a mixture of calcium, aluminum and ferrous silicates. In the conductive concretes being here discussed, the sand, stones and other minerals normally employed as aggregate are replaced by carbon in one of its forms.

Optionally, the various forms of carbon can be admixed with the aggregates and other additives commonly known in the art, providing the concentration of carbonaceous material is sufficient to provide the necessary electrical conductivity.

The shallow trench procedure involves the following steps: a trench is first dug in the earth adjacent to the equipment to be protected, normally to a depth of 20 to 30 inches below the surface, and to a length of up to 600 lineal feet, depending on the electrical resistivity of the soil. The trench is then partially filled with the carbonaceous cementitious material either in the form of a dry powder, or as a water based slurry. Then the required conductive metallic wire or rod is embedded in this cementitious composition and the trench is back-filled with the previously removed earth, tamped, and the conductor connected to the equipment to be protected. If dry powder is employed, the hydraulic cement sets by withdrawing sufficient water from the soil to meet the requirements of a total cure.

U.S. Pat. No. 6,121,543 (Hallmark) describes a groundbed electrode comprising a horizontally-oriented copper, or other electrically-conductive metal conductor, embedded in a cementitious sheath containing approximately equal parts of Portland cement and powdered crystalline carbon. The cementitious sheath may contain from approximately from 45 parts to 55 parts crystalline carbon powder, with the balance being Portland cement. In a related type of application U.S. Pat. No. 3,941,918 (Nigol) discloses a conductive cement for use with electrical insulators in which graphite fibers are used to form a conducting network within a combination of Portland cement, graphite fibers and high structure carbon black to provide an electrically conductive cement with high compressive strength. Related applications of carbonaceous materials in a concrete matrix for use on various surfaces walkways, floors roadways and the like are described in U.S. Pat. Nos. 3,573,427 and 3,962,142.

More recently Bennett in U.S. Pat. No. 5,908,584 has described an electrically conductive building material comprising a mixture of graphite, amorphous carbon, sand, and a cement binder to shield building materials from against electromagnetic radiation.

GB Patent 1 424 162 (February, 1996) discloses electrically conducting coatings based on cement containing dispersed graphite which cuts frequencies between 20 KHz to 50 KHz, while the French disclosure FR-A-2216 (August, 1974) describes coatings based on cement and carbon for use as structural grounding connections, anti-static floors and walls for cutting frequencies.

(ii) Deep Well Grounding

Deep well beds provide an effective method of increasing the life of subsurface metallic structures. Cathodic protection depends on the effective life of the electrode used to establish current flow, and the use of metallic anodes in combination with various carbon and graphite electrodes is now widespread.

With this procedure the cost of electrode replacement becomes an important consideration, the rate of anodic consumption being dependent on the current density at the interface of the anode and soil medium. It has been found that a more uniform flow of current can be achieved if the anode is completely surrounded by a uniformly conductive backfill material. Such materials are generally carbonaceous, and include granular, fine grain or pulverized carbon substances, calcined coke and graphite and the like.

According to the deep well technique a hole is drilled in the soil near the structure to be protected to an approximate depth of 150 to 450 feet, and a diameter of four or more inches. An anodic chain is then lowered into this hole and the hole is then filled with the backfill material, optionally containing an aqueous slurry.

It is important that the composition of the fill be of such nature that the anodic gas produced over the course of the corrosion process has a means to escape. This gives rise to a number of difficulties, solutions to which have been sought, for example, in the use of prepackaged anodes emplaced in special containers or rigid cartridges (U.S. Pat. Nos. 3,725,699 and 4,400,259), or a more flexible construction which retains its shape and is thus more readily transported and installed U.S. Pat. No. 4,544,464 (Bianchi et al.). According to the latter, a perforated disk filled with coke and sufficiently elastic to facilitate electric current between the central anode and the external casing, combined with backfill composed of graphite and coke such that the anode is homogeneously surrounded by backfill in order to provide consistent current flow as the corrosion continues.

A number of patents describing the deep well or deep anodic process were issued to Joseph Tatum (Cathodic Equipment Engineering, Hattiesburg, MS) between 1973 and 1992. This U.S. Pat, No. 3,725,669 discloses a system of deep anodes while later disclosures are directed to improving Tatum's system by the inclusion of various dielectric casings and windows. U.S. Pat. No. 4,786,388, describes a low resistance non-permeable backfill for cathodic protection of subsurface metallic structures consisting of a mixture of carbonaceous materials, lubricants, Portland cement and water. In this process the slurry was pumped into the previously disclosed anode bed.

It is desirable for environmental reasons that anode beds be designed in such a manner that liquid from the anode be separated from any water bearing strata in the vicinity. To this end the '388 patent (Tatum) describes a method of pumping an electrically conductive cementitious backfill into the well in such a way as to produce a groundbed construction with a non-permeable concrete annulus in contact with the earthen bore. This improvement is said to avoid water quality degradation while at the same time achieving a low resistance ground contact. As so described the material used on the outside of the casing and the conventional anodes and carbonaceous backfill on the inside of the casing provide a non-permeable but conductive grout to prevent contamination of water. The system so described is a double annulus: the low porosity cementitous composition is not intended for direct contact with the anode, conventional carbonaceous material being recommended for the confines of the casing.

U.S. Pat, No. 5,080,773 (Tatum) describes an electrical ground installed in the earth comprising an electrical conductor, a bore hole and a conductive non-porous carbonaceous cement composition surrounding said conductor and in contact with said rod by means of earth. These compositions are said to have enhanced conductivity, decreased porosity and a rate of set similar to that of conventional concrete.

The known methods of manufacturing carbonaceous concrete as reviewed herein suffer from a number of weaknesses. One particular concern relative to use in the shallow trench method is inadequate quality control due to the variable nature of in situ curing, and poor freeze thaw resistance.

The deep well method is also subject to a number of significant drawbacks, the most serious being the difficulty in controlling the movement of anodic gases and ground water. The attempts made to date to achieve the correct balance which would allow the anodic gases to escape, while the flow of water is reduced are far from adequate, and the annular method described by Tatum is both difficult to install and control.

Methods of Manufacturing Portland Cement-Based Concrete Compositions

In order to appreciate the below-described improvements afforded by the manufacturing processes and compositions within the present invention, it is useful to review briefly manufacturing modifications currently used in the art of Portland based concrete manufacture, namely, addition of fibers; entrainment of air bubbles; and waterproofing additives.

(i) Fibrated Cement

Fiber reinforced concrete is conventional concrete to which discontinuous discrete fibres have been added during mixing. See, e.g. U.S. Pat. Nos. 4,407,676 and 4,414,030 (Restrepo) Exemplary fibers comprise steel, glass, carbon fiber, cellulose fiber, cellulose, rayon or synthetic materials such as polyolefins, nylon, polyester and acrylics. Fibers are known to reduce plastic shrinkage of concrete, and to provide additional strength and reinforcement of the concrete against impact damage and crack.

One concern is the long term stability of alkaline sensitive fibers in the high pH environment prevalent in Portland cement matrix. Polyesters, nylon and even alkali resistant glass fibers become brittle after prolonged storage in moist environments. Polyolefin fibers meet many of the requirements being chemically and thermally stable, inexpensive and possessing excellent mechanical properties such as strength, stiffness and extensibility. Polypropylene fibers may be used in the monofilament, fibrillated or ribbon forms, and in an array of shapes (round, flat, crimped), sizes (from 6 to 150 mm) and diameter (0.005 to 0.75 mm). One problem with polypropylene is poor compatibility with Portland cement, a problem addressed by Berke et. al. (1999) and Pyle (2001) who describe a method of modifying the polypropylene by coating it particular glycol ethers.

(ii) Freeze Thaw Resistance and Air Entrainment

The most destructive weathering factor experienced by concrete is that caused by repeated cycles of freezing and thawing. ASTM C666 allows calculation of a durability factor that reflects the number of cycles of freezing and thawing required to produce a certain amount of deterioration. The most common solution to the problem of freeze-thaw degradation involves air entrainment of the concrete. It is known that the presence of air in the paste provides small compressible pockets which relieve the hydraulic pressure generated during freezing. The optimal air content is between 4 and 8%, this being achieved by addition of air-entraining agents that stabilize the bubbles formed during the mixing process. Preferred air entraining additives include resinous acids and synthetic detergents.

(iii) Permeability, Water Tightness and Waterproofing

Water tightness is the ability of concrete to hold back or retain water without visible leakage; permeability refers to the amount of water migration through concrete when the water is under pressure. The permeability of good quality concrete is approximately 10⁻¹⁰ cm per second. Waterproofed portland cement is usually made by adding a small amount of stearate or oleate soaps (calcium, aluminum or other) or esters (e.g. butyl stearate) to the Portland cement. This reduces capillary water transmission but does not stop water-vapour transmission

As described in the above review, it is known to protect installations from electrical currents by the installation of ground electrodes in which a metallic rod is immersed in a conductive sheath consisting of various types of amorphous and crystalline carbon in combination with a cementitous compound such as Portland cement. The known methods of manufacturing such carbonaceous concrete, and their performance properties known to date do, however, suffer from a number of serious weaknesses that reduce their commercial and technical advantages.

A first such disadvantage arises from the fact that when carbonaceous cement is cured in situ in the Shallow Trench process, the condition of the final product depends on variable conditions of application, such as the degree of compaction during filling, water content, soil permeability, ambient temperature, etc. The method of installing conductive cements in deep wells by in situ placement is also subject to severe variability in quality.

A second general disadvantage to which currently used carbonaceous concretes are subject arises from the freeze/thaw conditions to which these material are subject in the field. In many geographic locations of the world, a thirty inch deep trench is above the frost line. Currently used carbonaceous concrete are notoriously subject to suffer rapid degradation in properties when subject to freezing and thawing under wet conditions, owing to the porous nature of the carbonaceous concrete. This problem has been addressed in the literature in this field, but hitherto any improvement in freeze/thaw properties wa believed to be possible only by using compositions with a very high cement-to-carbon ration, a condition which seriously compromises the electrical conductivity of the product.

Thirdly, the presence of porous carbon in known carbonaceous cement compositions generally affords little or no resistance to the undesired flow of water through the soil. This is of particular concern in the deep well application; as noted above, poor permeability of the concrete surrounding the anode can significantly and detrimentally affect the quality of water in the vicinity.

### SUMMARY OF THE INVENTION

With a view to overcoming the aforementioned disadvantages of known carbonaceous cement compositions and their methods of manufacture, the present invention according to a first embodiment is directed to a method of improving the freeze thaw resistance of carbonaceous concrete by the incorporation of fibers into a carbon-cement slurry prior to curing.

According to a second embodiment, water resistance of the produce is improved by the addition of a fatty acid alkali metal soap to the water used to prepare a slurry of carbonaceous cement for curing into a protective casing material for a grounding anode.

According to a third embodiment, the invention is directed to a method of precasting carbonaceous cement using a lower water content than is typically used in molding conventional concrete, to reproduceably yield anodes with improved properties.

According to a fourth embodiment of the invention, pre-cast carbonaceous cement made as aforesaid is used for the encasement and protection of deep well anodes, significantly extending their working life.

### DESCRIPTION OF PREFERRED EMBODIMENTS

The Examples shown below disclose the results obtained with modification of compositions containing mixtures of coke breeze and Type 10 Portland cement. While the ratio of coke breeze to cement can in theory cover a wide range, we have found that it is preferable to maintain the concentration of coke breeze between about 45 and 55% by weight. When the concentration of coke is below about 45% there is a decline in conductivity of the composition, while if the concentration of coke is greater than about 55% there is insufficient cement in the product to provide the required strength. In the discussion which follows this carbonaceous concrete is abbreviated to “CC”.

The first embodiment of the invention stems from our discovery that the freeze thaw resistance of CC can be greatly improved by the incorporation of fibers of various types. Although fibers have long been used in the manufacture of concrete, they have not been used or suggested to be used in improving the freeze thaw resistance of concrete.

In our experiments we found that incorporation of conventional freeze thaw additives was ineffective in improving this property in carbonaceous cement. We theorize that the explanation for this observation is that the conventional additives used to improve freeze thaw resistance achieve their effect by generating foam such that the air void content is between 4 and 8%. Since the air content of CC is significantly higher than 8% (being commonly in the range of 20-35%), the types of foaming agents normally used were ineffectual.

In a different attempt to address the freeze-thaw problem we tested numerous water reducing agents with a view to lowering the air content to the preferred range. Although certain of these additives were found helpful in reducing water permeability, none was found capable of improving the freeze thaw resistance of the product.

Fibers of various types were, surprisingly, found to be very effective in improving CC freeze-thaw resistance. This effectiveness was observed whether the fibers derived from natural plant materials sources (e.g. cellulose) or synthetic polymers (nylon, polyacrylate, polyester, polyolefins), or glass. As noted above, not all fibers are suitable for long term use in the alkaline environment prevalent in Portland based concrete, some of them being subject to alkaline hydrolysis. The preferred fibers for this application are believed to be cellulose derivatives, polyolefins such as polypropylene, and acrylics. This embodiment is illustrated in Example 1.

The second embodiment of the invention derives from our discovery that the water absorption of the CC may be greatly improved by incorporating the soaps of long chain fatty acids. The migration of water through CC is particularly problematical due to the high degree of voids caused by the carbon particles.

As noted, it has long been known that the water resistance of conventional concrete can be improved by the addition of various additives such as the insoluble salts of fatty acids, oils, waxes and the like. But, after numerous experiments on carbonaceous concretes, we found that none of the known and commercial cement waterproofing agents, were successful. We then discovered, to our surprise, that water permeability of carbonaceous concrete may be greatly improved if a fatty acid is introduced to the uncured composition, either in the form of its soluble alkaline soap or by conversion in situ to the insoluble alkali earth soaps, these being formed by addition of the hydroxides or soluble salts of alkali earth metals to the composition.

Although the mechanism of this process is not fully understood, we conjecture that the high water cement ratio required for carbonaceous concrete may prevent uniform dispersion of the largely insoluble waterproofing additives. In the case of the soluble soaps of fatty acids, these first disperse uniformly in water later react with the lime that is produced as a by-product of the curing of the cement to produce a uniform dispersion of calcium soaps.

In our experiments we have found that the soaps of both oleic and stearic acid are effective in this process, and it may reasonably be expected that numerous other fatty acids might also be so employed. As illustrated in Examples 2 and 3, the degree of water resistance is directly related to the concentration of fatty acid soap included in the composition. This simple, inexpensive and effective method of controlling the permeability of conductive concrete is superior to the complex annular techniques previously disclosed.

The third embodiment of the invention is the disclosure of a pre-casting process which is especially useful in preparing carbonaceous concrete for use in protective ground anodes. Although pre-casting of conventional concrete is a long established method of production, pre-casting has not previously been described for successful use with carbonaceous concrete. The process of the present invention differs significantly. The pre-casting of conventional concrete usually involves the preparation of a cementitious slurry with water, which slurry is poured into a mould, tamped, de-aerated and allowed to cure. This technique is not suitable for carbonaceous concrete because the rheological nature of CC slurry compositions is such that unusually large quantities of water before it can be placed in moulds. This excess water both retards the cure rate and can result in shrinkage and cracking problems. This property is a consequence of the fact that the various forms of carbon commonly used in CC are extremely porous and irregularly shaped.

Another difficulty arises from the fact that coke breeze is somewhat lighter than Portland cement as a consequence of which some separation of the ingredients can occur during the extended curing time required for such a slurry. In the course of investigating this problem we discovered that if the carbonaceous cement is first compacted in the dry form into the mould, and water then added, a pre-cast form of lower water content and superior performance can be conveniently prepared. As illustrated in Example 3, preparation of a slurry from CC suitable for wet casting requires 64 parts of water per 100 parts of CC by weight. This is some two to three times more water than is typically required for the manufacture of conventional concrete. Preparation of carbonaceous concrete using the dry-pack process lowered the quantity of water required to 47 parts per hundred, a reduction of 26%. As shown in the example in addition to the process being easier to control, this process resulted in a product with improved properties thus improving the properties of the final product.

The fourth embodiment of the invention involves the use of pre-cast carbonaceous cement for the protection of deep well anodes. We have found that the working life of anodes used commercially in deep-well applications can be significantly extended if they are protected with CC. This protection is accomplished by embedding the anode in carbon-concrete cast in a mould. This is illustrated in Example 5. In the example shown the conditions were accelerated by using the maximum current density recommended by the anode manufacturer, and exposing the anodes to a solution of 3% sodium chloride. This concentration was chosen because it is approximately that of sea water, to which some deep well anodes are subject. This is a particularly damaging environment due to the formation of chlorine gas which occurs during the electrolytic process.

### EXAMPLES

### Example 1

### Improved Freeze Thaw Resistance of CC by Incorporation of Fibers

A carbon-cement slurry was prepared by mixing 100 parts by weight of CC control with 60 parts water. Samples were prepared in standard 4″×2″ cylindrical plastic moulds in which they were cured for 28 days at 50% relative humidity. The CC control consisted of 50/50 w/w % coke breeze and Type 10 portland cement (St. Marys Type 10). In each case described below the fibers were blended in dry before addition of the water. The table below reveals the number of freeze thaw cycles which the samples were subjected to before they were considered to have failed due to excessive crumbling and a weight loss of greater than 30%. The recycled cellulose was Interfibe 230 (Interfibe Corp), the Recycled polyester was fine dernier cuttings, ½″ in length supplied by Recycled Plastic Technologies (Akron Ohio); the fiberglass was supplied by Fibreglass Canada and the fibrillated polypropylene was purchased from Pro-mesh Fiber.

| Additive | Percent w/w | F/Tcycles failure |
|---|---|---|
| None (control) | 0 | 5 |
| Recycled cellulose | 1.0 | 29 |
| Recycled cellulose | 5.0 | 37 |
| Recycled polyester | 0.5 | 29 |
| Recycled polyester | 2.0 | 29 |
| Fiberglass | 1.0 | 20 |
| Fiberglass | 2.0 | 20 |
| Polypropylene | 1.0 | 11 |

### Example 2

### Incorporation of Fatty Acid Alkali Metal Soaps to Improve Water Resistance

In this experiment samples were prepared and cured as described above for 28 days. The results below were obtained using the sodium soaps of Pamak C4, a distilled tall oil fraction manufactured by Hercules Canada (Burlington, Ontario). In this experiment a 25% solution of soap was admixed with the water used to prepare different slurries of the carbonaceous cement. These were then transferred to standard 2″×4″ cylinders where they were cured for 28 days. The test cylinders were then removed from the moulds and dried under ambient conditions for 7days and weighed. Each was then immersed in water for 4 hours after which it was removed from the water, dried with a paper towel and weighed again. The Table below shows the increase in weight due to absorption of water for samples containing different quantities of soap. In each case the soap content is expressed on a dry basis. The results demonstrate that the rate water uptake is directly proportional to the concentration of soap in the concrete. Addition of calcium chloride to the samples did not appear to affect the results suggesting that the performance is related to reaction of the soaps with free calcium in the cured concrete

| Soap content | Wt inc. after | Uptake |
|---|---|---|
| (% w/w) | 4 hrs (%) | rate (hrs/%) |
| 0 | 20 | 0.20 |
| 0.5 | 11 | 0.36 |
| 1.0 | 10 | 0.40 |

### Example 3

### Utilization of Alkali Earth Fatty Acid Salts to Improve Water Resistance

This series of experiments was conducted as described in Example 2 above, with the exception that the fatty acid soap formation was modified by incorporation of calcium ions, either by adding calcium chloride solution to the slurry, or by including slaked lime in the dry CC mix.

| Soap content | Wt inc. after | Uptake | |
|---|---|---|---|
| (% w/w) | 4 hrs (%) | rate (hrs/%) | Note |
| 0 | 20 | 0.20 | |
| 4.0 | 3.0 | 1.3 | 0.7% CaCl₂ post-added |
| 4.2 | 2.5 | 1.6 | 0.7% CaCl₂ post-added |
| 4.6 | 4.0 | 1.0 | 3% lime in dry mix |

### Example 4

### Manufacture of Cementitious Concrete Using a Dry Pre-Cast Process

Casting of a CC slurry in the conventional manner was carried out by adding sufficient water to 217 gms of CC to prepare a slurry of such viscosity that it could be poured into a 2″×4″ test mould. This required 140 gms water, or 64 parts water per hundred parts CC.. This slurry was then poured into the test cylinder and cured for 5 days after which it was removed and crushed. The compressive strength was 310 psi.

To prepare a-sample of pre-cast CC, 2″×4″ test cylinder was filled with dry CC and tamped until it had fully settled. The net weight was 205 gms. Water was slowly added and allowed until the whole was fully saturated. The final net weight of water required was 96 gms, or 47 parts water per hundred parts CC. After curing for 5 days the crush strength of the CC was found to be 410 psi.

### Example 5

### Simulation of the Use of Precast Anodes for Deep Well Application

The experiment described in this example utilized commercial High Silicon Cast Iron anodes manufactured by Anotec Industries (Langley, BC) with dimensions of 1.5″ diameter×12″ in length. Both control and test anodes were protected with an epoxy cap and connected to the rectifier by means of HMWPE cable. The test anode was encased in a 1.5″ layer of CC using the pre-casting technique described above with a plastic mould 4″ in diameter and 12″ long.

The concrete was cured 14 days before commencing the test. This was conducted using two test cells consisting of 20 litre plastic pails filled with 30 mesh silica sand saturated with 3% sodium chloride solution. The test anodes were in the centre of each pail, while the cathodes consisted of a 12″×12″ steel plates positioned against the wall of the pail. A variable current power supply from Spence Tek Inc (Milpitas Calif.) ensured that the current to each test anode during the course of the trial was the same, and maintained within the range 0.75±0.5 amps. The uncoated and coated anodes received 0.54 and 0.31 kamp-hours respectively, and the voltage in each pail varied from 4 to 6V.

The anodes were weighed at the beginning and end of the 30 day test period after which both were. removed from their individual pails and examined after the CC coating was removed from the test anode. The control anode appeared to be more pitted than the CC anode, but both were covered with a loose black coating which was flaked off before re-weighing the anodes. The weight loss of the uncoated control anode was 22 gms (0.8%) while that of the CC coated anode was 15 gms (0.6%).

1. A curable electrically conductive carbonaceous cement composition for use in the encasement of a ground electrode, comprising a slurry made of water, a hydraulic cement, a particulate, electrically conductive form of carbon and discontinuous discrete fibers of a material chemically stable in the slurry.

2. A curable carbonaceous cement composition according to claim 1, wherein said hydraulic cement is Portland cement.

3. A curable carbonaceous cement composition according to claim 2, wherein said form of carbon is selected from the group consisting of graphite, coke and coke breeze.

4. A curable carbonaceous cement composition as defined in claim 3, wherein said fibers are of a material selected from the group consisting of cellulose and its derivatives, polyolefins, and acrylics.

5. A method of preparing an electrically conductive carbonaceous cement slurry which is curable into a protective casing for a ground electrode, comprising the steps of:
(i) mixing a particulate, electrically conductive form of carbon with a hydraulic cement;
(ii) dry blending a selected quantity of fibers of a material chemically stable in the slurry; and
(iii) stirring the blend with water to form the carbonaceous cement slurry.

6. A method according to claim 5, wherein said hydraulic cement is Portland cement, said particulate electrically conductive form of carbon is coke breeze in an amount making up from 45 to 55% by weight of the total of coke breeze and Portland cement, and wherein said fibers make up from 0.5 to 2.0 weight per cent of the slurry.

7. A method according to claim 5, wherein the material of said fibers is selected from the group consisting of recycled cellulose, fiberglass and polypropylene.

8. A method according to claim 5, wherein prior to slurrying with the carbon, cement and fibers, said water is admixed with a solution of a metal soap selected from the group consisting of alkali metal salts of fatty acids and alkaline earth salts of fatty acids in an amount to bring the soap concentration to between 0.5 to 1.0% by weight in said slurry.

9. A method according to claim 8, wherein said metal soap is a sodium soap of Pamak C4 (trade-mark).

10. An electrically conductive carbonaceous cement composition for use in the encasement of a ground electrode, comprising a slurry of water, a hydraulic cement, a particulate electrically conductive form of carbon and a metal soap selected from the group consisting of alkali metal salts of fatty acids and alkaline earth salts of fatty acids.

11. A composition according to claim 10, wherein said hydraulic cement is Portland cement and said form of carbon is coke breeze.

12. A composition according to claim 11, wherein said coke breeze make up from 45 to 55% by weight of the total weight of coke breeze and Portland cement.

13. A composition according to claim 11, wherein said metal soap is present in an amount of from 0.5 to 1.0% by weight of said slurry.

14. (canceled)
